(19) United States
(12) Patent Application Publication
(10) Pub. No.: US 2026/0020996 A1
(43) Pub. Date: Jan. 22, 2026

(54) Patient Support System Having A Foot Barrier

(71) Applicant: Stryker Corporation, Portage, MI (US)

(72) Inventors: Ashish Sagar, Gurgaon (IN); Kevin M. Patmore, Plainwell, MI (US); Shubham Ravindra Pokle, Nagpur (IN); Justin Jon Raymond, Jackson, MI (US); Jaspreet Sethi Singh, Haryana (IN)

(73) Assignee: Stryker Corporation, Portage, MI (US)

(21) Appl. No.: 19/271,935

(22) Filed: Jul. 17, 2025

Related U.S. Application Data
(60) Provisional application No. 63/672,320, filed on Jul. 17, 2024.

(51) Int. Cl. A61G 1/048; A61G 1/003; A61G 1/02

(52) U.S. Cl. CPC A61G 1/048; A61G 1/003; A61G 1/02; A61G 2203/76; A61G 2203/80

(57) ABSTRACT

A patient support system includes a patient transport apparatus. The patient transport apparatus includes a base, a litter, a deck section, and a mattress. The patient support system includes a foot barrier operatively attached to the litter. The foot barrier includes a bottom, a shield having a center panel pivotally coupled to the bottom, and a pair of side panels each pivotally coupled to the center panel. The shield being operable between a stowed configuration where the center panel and the side panels are disposed between the deck section and the mattress, and a deployed configuration where the center panel and the side panels extend at least partially above the mattress for shielding a caregiver from at least a portion of the patient. The foot barrier includes a brace coupled to the shield and arranged for attachment to the litter to maintain the shield in the deployed configuration.

### CROSS-REFERENCE TO RELATED APPLICATION

The subject patent application claims priority to and all the benefits of U.S. Provisional Patent Application No. 63/672,320 filed on Jul. 17, 2025, the disclosure of which is hereby incorporated by reference in its entirety.

### BACKGROUND

Patient support systems facilitate care of patients in a health care setting. Patient support systems comprise patient transport apparatuses such as, for example, hospital beds, stretchers, cots, tables, wheelchairs, and chairs. A conventional patient transport apparatus generally includes a base and a litter upon which the patient is supported via one or more deck sections.

Patient support systems facilitate care of patients in a health care setting. Patient support systems comprise patient transport apparatuses such as, for example, hospital beds, stretchers, cots, tables, wheelchairs, and chairs. A conventional patient transport apparatus generally includes a base and a litter upon which the patient is supported via one or more deck sections.

In situations involving patient transport, such as where a cot is used to transport a patient from an incident scene to a hospital or similar healthcare facility, caregivers are often positioned within close proximity to the patient's body supported on the litter, especially where the patient is relatively tall. In some circumstances, the patient's feet may be positioned near the caregiver's face or hands, which can present cleanliness issues and lead to general discomfort for caregivers. Conventional approaches to these issues typically involve placing a sheet, blanket, or another object around or near the patient's feet to create a barrier for the caregiver. However, this conventional approach is time consuming and cumbersome, especially in emergency scenarios, and may become unsecured or otherwise loosen during transport.

Accordingly, there remains a need in the art to overcome one or more of the disadvantages described above.

### SUMMARY

This Summary introduces a selection of concepts in a simplified form that are further described in the Detailed Description. This Summary is not intended to limit the scope of the claimed subject matter nor identify key features or essential features of the claimed subject matter.

According one aspect, a patient support system is provided. The patient support system include a patient transport apparatus. The patient transport apparatus includes a base supporting a plurality of wheels arranged for movement along a floor surface, a litter supporting a patient support deck, and a mattress disposed on the patient support deck to support a patient. The patient support system includes a foot barrier being operatively attached to the litter. The foot barrier includes a bottom and a shield having a center panel pivotally coupled to the bottom. The shield includes a pair of side panels each pivotally coupled to the center panel. The shield may be operable between: a stowed configuration where the center panel and the side panels are disposed between the patient support deck and the mattress, and a deployed configuration where the center panel and the side panels extend at least partially above the mattress for shielding a caregiver from at least a portion of the patient. The foot barrier includes a brace coupled to the shield and arranged for attachment to the litter to maintain the shield in the deployed configuration.

Any of the above aspects may be combined in part, or in whole, with any other aspect. Any of the aspects above may be combined in part, or in whole, with any of the following implementations.

In some implementations, the patient support system is configured where the center panel is arranged parallel to the side panels in the stowed configuration.

In some implementations, the patient support system is configured where the center panel is disposed adjacent to the bottom in the stowed configuration and pivots away from the bottom to a center panel angle in the deployed configuration.

In some implementations, the patient support system is configured where the brace includes an adjuster arranged for user engagement to modify the center panel angle.

In some implementations, the patient support system is configured where the side panels are each disposed adjacent to the center panel in the stowed configuration and pivot away from the center panel to respective side panel angles in the deployed configuration.

In some implementations, the patient support system is configured where the brace includes an adjuster arranged for user engagement to modify one or more of the center panel angle and the side panel angles.

In some implementations, the patient support system is configured where the center panel angle is one of an acute angle, a right angle, an obtuse angle, or a reflex angle.

In some implementations, the patient support system is configured where the respective side panel angles are a right angle or an obtuse angle.

In some implementations, the patient support system is configured where the mattress defines a longitudinal mattress end; and wherein the center panel of the shield abuts the longitudinal mattress end in the deployed configuration.

In some implementations, the patient support system is configured where the mattress further defines first and second lateral mattress sides, and first and second tapered mattress edges extending respectively between the first and second lateral mattress sides and the longitudinal mattress end; and wherein the side panels of the shield each respectively abut one of the first and second tapered mattress edges in the deployed configuration.

In some implementations, the patient support system is configured where the center panel defines a front center panel face and an opposing back center panel face; wherein the front center panel face is disposed adjacent to the patient support deck in the stowed configuration; and wherein the back center panel face abuts the mattress in the stowed configuration.

In some implementations, the patient support system is configured where the foot barrier further includes a pocket coupled to the back center panel face for storing equipment.

In some implementations, the patient support system is configured where the brace includes a center brace operatively attached to the center panel, and a pair of side braces operatively attached to the litter adjacent to the patient support deck and coupled to the center brace and to maintain the shield in the deployed configuration.

In some implementations, the patient support system is configured where the brace further includes a pair of fasteners each coupled to a respective one of the side braces and to the center brace, the fasteners being operable between: an engaged fastener state to maintain the shield in the deployed configuration with the side braces coupled to the center brace, and a released fastener state for releasing the side braces from the center brace.

In some implementations, the patient support system is configured where the side braces each include a respective side strap defining a loop segment for attaching the side braces to the litter.

In some implementations, the patient support system is configured where the side braces each include a respective side strap; and wherein the fasteners each include a first buckle end coupled to the center brace, and a second buckle end attached to one of the side straps.

In some implementations the patient support system is configured where the center brace includes: a center mount operatively attached to the center panel of the shield, a pair of adjusters coupled to the center mount, and a pair of center straps extending through the respective adjusters and operatively attached to the first buckle ends of the respective fasteners.

In some implementations, the patient support system is configured where the center straps of the brace are routed through the adjusters for adjustment to pivot the shield relative to the bottom.

In some implementations, the patient support system is configured where the brace further includes a pair of pull handles operatively attached to the center straps and arranged for engagement to adjust the center straps.

In some implementations, the patient support system is configured where the center brace further includes a center handle operatively attached to the adjusters.

In some implementations, the patient support system is configured where the foot barrier further includes a mount spaced from the brace for securing the foot barrier for movement relative to the litter between the stowed configuration and the deployed configuration.

In some implementations, the patient support system is configured where the mount is operatively attached to the bottom of the foot barrier.

In some implementations, the patient support system is configured where the mount includes: a mount strap arranged for engagement with at least a portion of the patient support deck of the litter, and a mount fastener coupled to the mount strap and configured to releasably secure the mount strap to the patient support deck of the litter.

In some implementations, the patient support system is configured where the mount strap is operatively attached to the bottom of the foot barrier.

In some implementations, the patient support system is configured where the center panel abuts at least one of the side panels in the stowed configuration.

In some implementations, the patient support system is configured where the foot barrier includes a cover enclosing the bottom and the shield.

In some implementations, the patient support system is configured where the cover defines a shield hinge between the bottom and the center panel.

In some implementations, the patient support system is configured where the cover defines side hinges between the respective side panels and the center panel.

In some implementations, the patient support system is configured where the litter includes an intermediate frame and a litter extension supported for movement relative to the intermediate frame between a plurality of litter extension positions including a retracted litter position and one or more extended litter positions; and wherein the bottom of the foot barrier is operatively attached to the litter extension for concurrent movement between the plurality of litter extension positions.

In some implementations, the patient support system is configured where the bottom of the foot barrier is operatively attached to the patient support deck of the litter.

Any of the above aspects may be combined in full or in part. Any features of the above aspects may be combined in full or in part. Any of the above implementations for any aspect may be combined with any other aspect. Any of the above implementations may be combined with any other implementation whether for the same aspect or a different aspect.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a perspective view of a patient transport apparatus of a patient support system according to versions of the present disclosure, shown having a litter with a litter extension arranged in a retracted position.

FIG. 2 is another perspective view of the patient transport apparatus of FIG. 1, shown with the litter extension arranged in an extended position.

FIG. 3 is another perspective view of the patient support system of FIGS. 1-2, shown with a mattress disposed on the litter.

FIG. 4 is another perspective view of the patient support system of FIG. 3, shown with a foot barrier arranged in a stowed configuration.

FIG. 5 is a front view of the foot barrier of FIG. 4.

FIG. 6 is a back view of the foot barrier of FIGS. 4-5.

FIG. 7 is another perspective view of patient support system of FIGS. 1-4, shown with the foot barrier arranged in a deployed configuration.

FIG. 8 is a side view of the foot barrier of FIGS. 4-7, shown arranged in a deployed configuration.

FIG. 9 is another side view of the foot barrier of FIGS. 4-8.

FIG. 10 is another side view of the foot barrier of FIGS. 4-9.

FIG. 11 is another side view of the foot barrier of FIGS. 4-10.

FIG. 12 is a partial perspective view of the foot barrier of FIGS. 4-11, shown arranged in a deployed configuration.

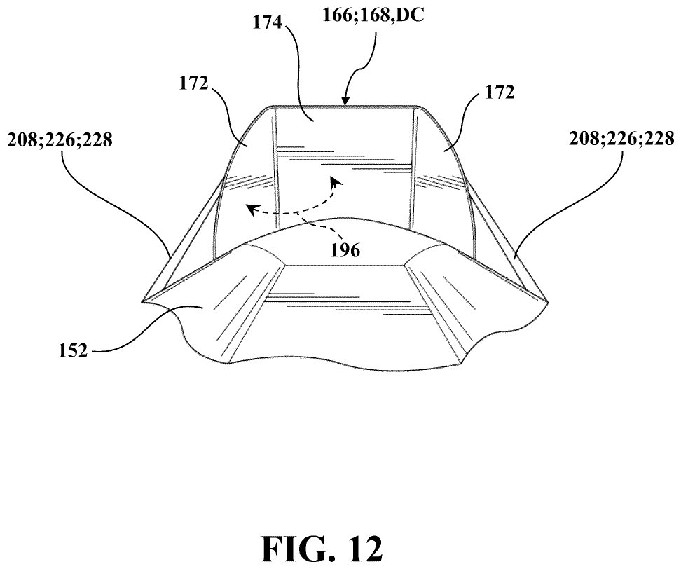

FIG. 13 is a partial top view of the patient support system of FIGS. 1-4, shown with the foot barrier arranged in a deployed configuration.

FIG. 14 is a partial perspective view of the patient support system of FIG. 13.

FIG. 15A is a perspective view of the patient support system of FIGS. 1-4, shown with the litter extension arranged in the retracted position and supporting the foot barrier arranged in the stowed configuration.

FIG. 15B is another perspective view of the patient support system of FIG. 15A, shown with the litter extension arranged in the extended position and supporting the foot barrier arranged in the stowed configuration.

FIG. 16 is another perspective view of the patient support system of FIG. 15B, shown with the mattress disposed on the litter.

FIG. 17 is another perspective view of the patient support system of FIG. 16, shown with the foot barrier arranged in a deployed configuration.

### DETAILED DESCRIPTION

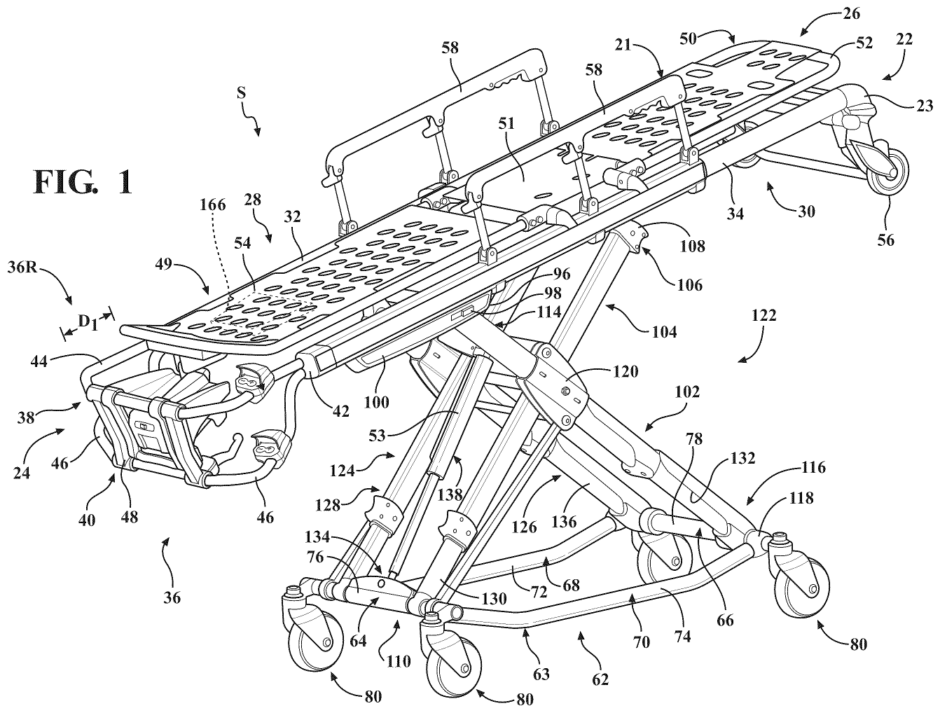

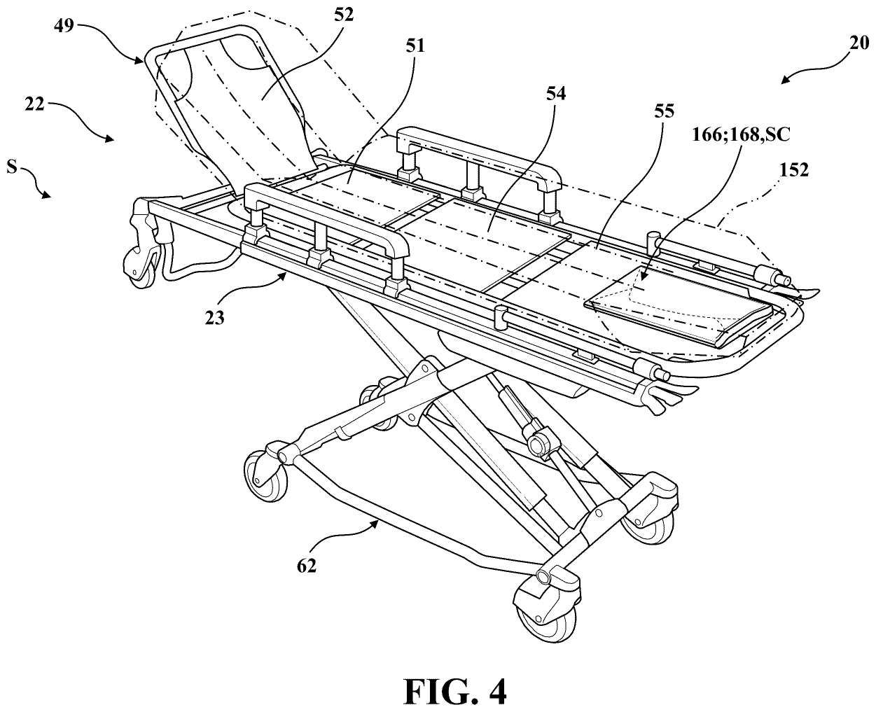

Referring to FIGS. 1-4, a patient support system S is shown. The patient support system S generally includes a patient transport apparatus 20 (see FIG. 1), and a foot barrier 166 (see FIG. 4), each of which will be described in greater detail below. In the representative versions depicted throughout the drawings, the patient transport apparatus 20 is realized as a cot for supporting a patient in a health care and/or transportation setting. In other versions, however, the patient transport apparatus 20 may be realized as a hospital bed, stretcher, table, wheelchair, chair, or similar apparatus utilized in the transportation and care of a patient.

The patient transport apparatus 20 generally includes a support structure 21 with a litter 22 defining a patient support surface 50 to support a patient, and a base 62 arranged for movement along ground surfaces GS, as described in greater detail below. In some versions, the patient transport apparatus 20 may be similar to as is described in one or more of U.S. Pat. Nos. 10,987,268 and 10,987,260, the disclosures of each of which are hereby incorporated by reference in their entirety. Other configurations are contemplated.

The support structure 21 may have various configurations and may include a variety of components. For example, the litter 22 may include a frame 23 (also referred to as an “intermediate frame” or “litter frame”) with two opposing lateral sides 24, 26 extending along the width coupled to a foot end side 28 and an opposing head end side 30 extending along the length. The frame 23 may have various configurations and may include a variety of components. As best shown FIG. 1, the frame 23 includes hollow side rails 32, 34 extending longitudinally between the end sides 28, 30. In the illustrated version, the frame 23 also includes first and second cross rails 33, 35 extending laterally between the side rails 32, 34 (not shown in detail).

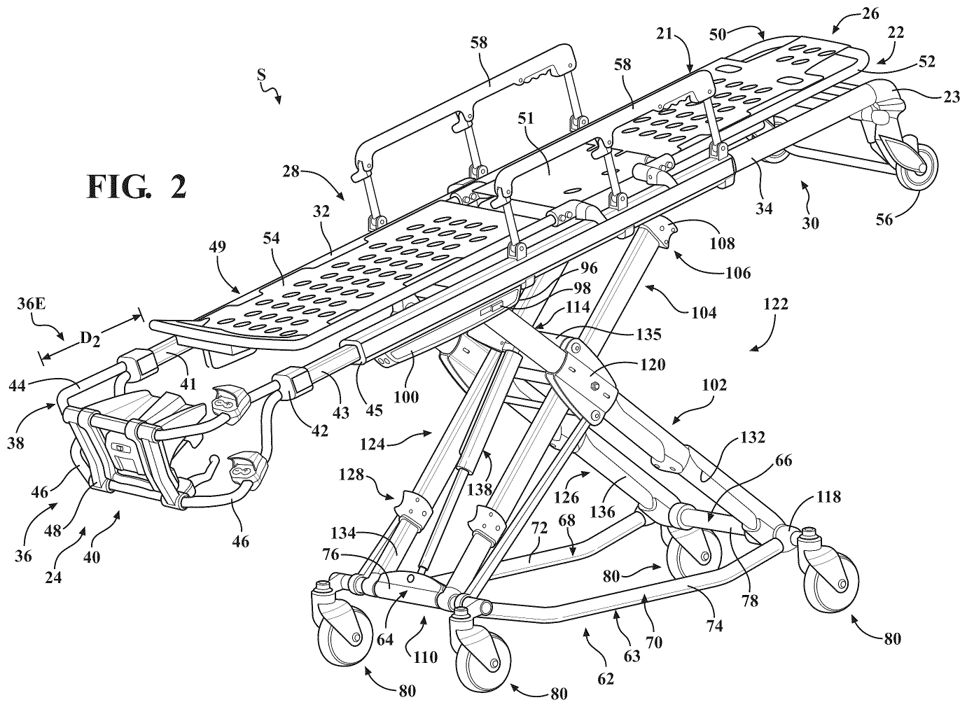

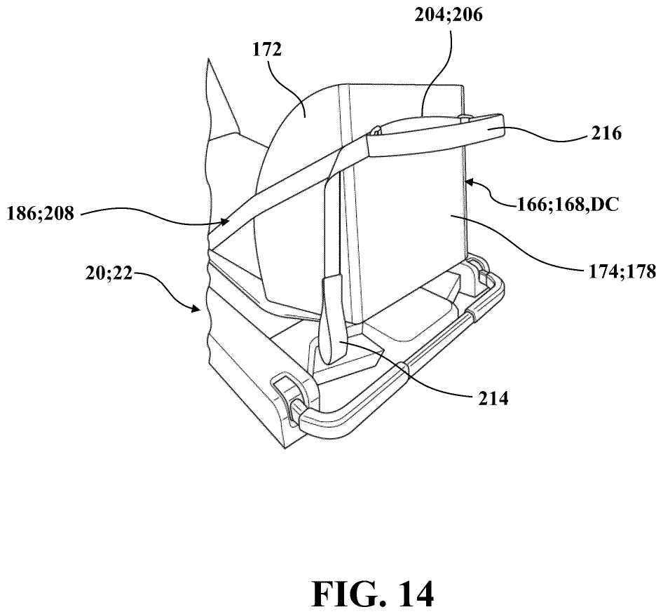

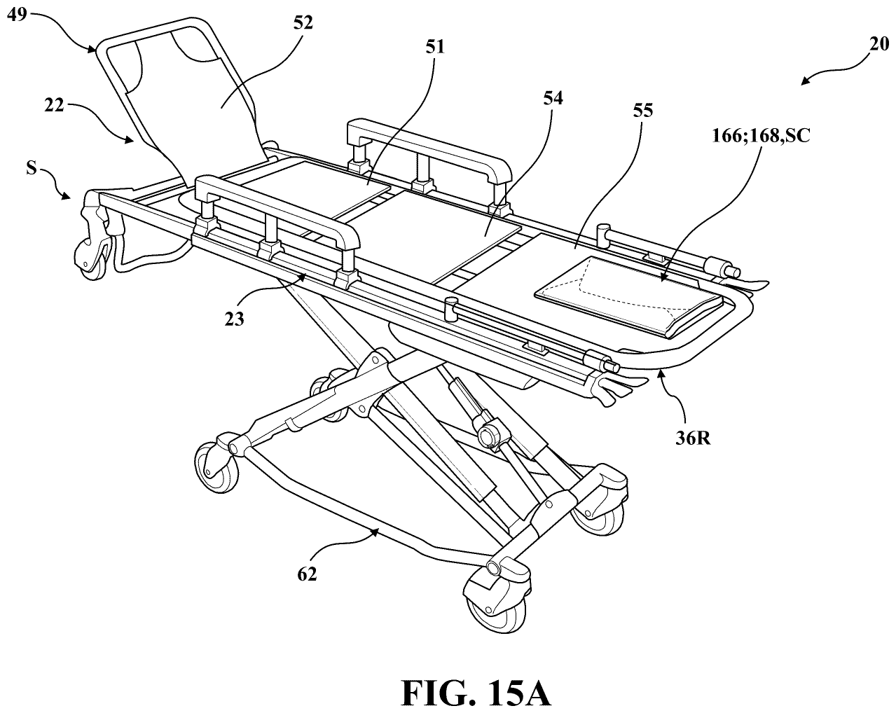

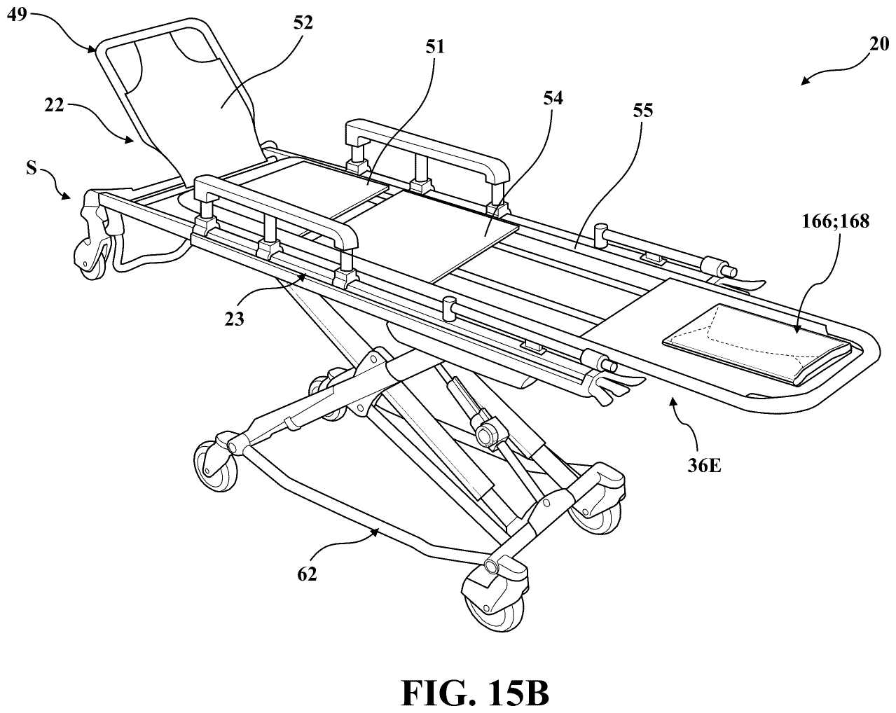

In some versions, the patient transport apparatus 20 also includes a litter extension 36 arranged adjacent to the foot end side 28, as shown in FIGS. 1-2. However, it will be appreciated that the litter extension 36 may be arranged in other ways, such as adjacent to the head end side 30. In some versions, the litter extension 36 may extend from any side of the litter 22, including from one of the lateral sides 24, 26. In some versions, multiple litter extensions 36 may be employed, such as with one arranged adjacent to the foot end side 28, one arranged adjacent to the head end side 30, and the like. Other configurations are contemplated. The litter extension 36 is supported for movement relative to the patient support surface 50 (or other portions of the support structure 21) between a plurality of litter positions including a retracted position 36R (see FIGS. 1 and 15A) and one or more extended positions 36E (see FIGS. 2 and 14B).

In some versions, the litter extension 36 may include a pair of vertically spaced U-shaped frame members 38 and 40. The frame members 38, 40 may be joined together by frame brackets 42 (only one frame bracket 42 is shown in FIG. 1) and operatively attached to joined frame members 41, 43 (not shown in detail), which may be telescopingly affixed inside side rails 32, 34 to facilitate movement between the litter positions 36E, 36R (compare FIGS. 15A-15B). The joined frame members 41, 43 are supported for movement into and out of the respective hollow side rails 32, 34 to extend an overall length of the litter 22. In the illustrated version, one or more components of the litter extension 36 are arranged at a first distance D1 relative to the hollow side rails 32, 34 in the retracted position 36R (see FIGS. 1 and 15A), and at a second distance D2 relative to the hollow side rails 32, 34 in the extended position 36E (see FIG. 1), wherein the first distance D1 is smaller than the second distance D2. In some versions, the frame members 38, 40 of the litter extension 36 may be arranged so as to define pairs of vertically spaced handling areas 44, 46 on frame members 38, 40, respectively. Here, spacer brackets 48 may be connected to opposing portions of each of the frame members 38 and 40 to maintain vertical spacing between the handling areas 44 and 46.

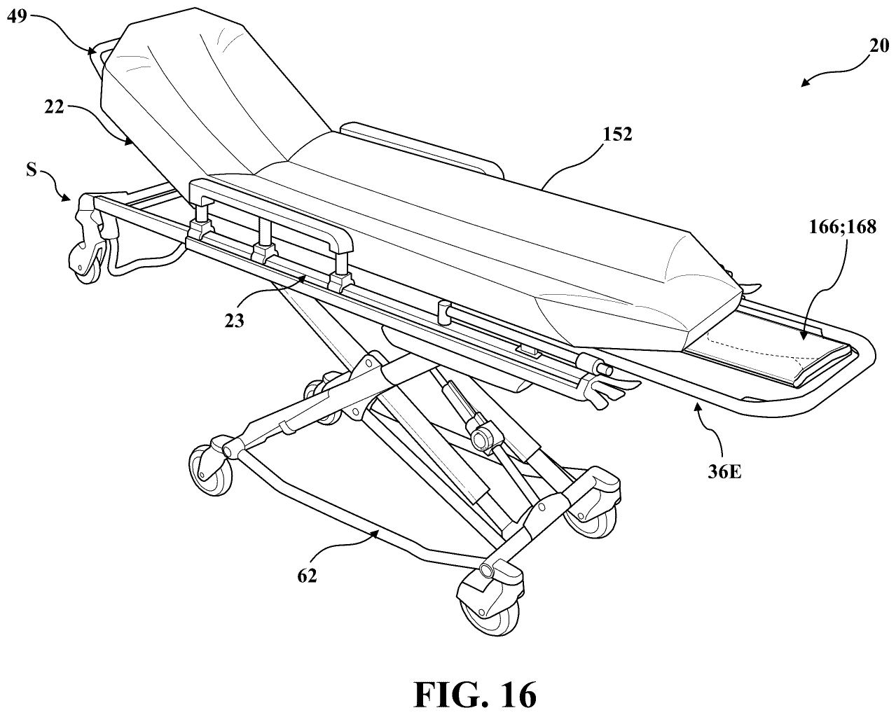

In some versions, such as the version depicted in FIGS. 15A-17, the litter extension 36 may be formed as a part of the patient support deck 49, such as by the foot section 55. It will be appreciated that this configuration allows the litter 22 to accommodate relatively tall patients.

The litter 22 may include or otherwise define various components or features which aid in supporting and/or transporting the patient. The litter 22 includes a patient support deck 49 operatively attached to the frame 23 and defining the patient support surface 50. In the representative version illustrated herein, the patient support deck 49 includes one or more deck sections, such as a seat section 51, a back section 52 (also referred to as a “fowler section”), a leg section 54 which may include an integrated foot section 55 (see FIGS. 1-2) or may be formed with separate leg and foot sections 54, 55 (see FIG. 4) to define an adjustable gatch. It will be appreciated that adjustment of the patient support deck 49 facilitates care and/or transportation of the patient in various patient positions. Other configurations are contemplated.

The litter 22 may also be coupled to loading wheels 56. As shown in FIG. 1, the loading wheels 56 may extend from the frame 23 proximal to the back section 52 of the patient support surface 50 and may facilitate loading and unloading of the patient transport apparatus 20 from a vehicle V. In some versions, the loading wheels 56 may be positioned and configured to facilitate loading and unloading the patient transport apparatus 20 manually into an emergency response vehicle V.

The litter 22 may also include hand rails 58. In FIG. 1, the hand rails 58 are shown extending from opposing lateral sides of the frame 23 and provide egress barriers for the patient on the patient support surface 50. The hand rails 58 may also be utilized by an individual, such as a caregiver, an emergency medical technician (EMT), or another medical professional, to move or manipulate the patient transport apparatus 20. In some versions, the hand rails 58 may include a hinge, pivot, or similar mechanism to allow the hand rails 58 to be folded or stored adjacent to or below the patient support surface 50.

As noted above, the support structure 21 of the patient transport apparatus 20 also includes the base 62, which is arranged for movement along ground surfaces GS. In the illustrated version, the base 62 employs a base frame 63 which includes two opposing lateral base sides 64, 66 extending along the width which are coupled to two opposing longitudinal base sides 68, 70 extending along the length. As shown in FIG. 1, the longitudinal base sides 68, 70 may include longitudinally-extending rails 72, 74 and the lateral base sides 64, 66 may include crosswise-extending rails 76, 78 which may be coupled at the ends thereof to the rails 72, 74. While the base frame 63 of the illustrated version of the base 62 has a generally rectangular profile, it will be appreciated that other configurations are contemplated, including versions where the base 62 is configured without a discrete base frame 63.

In order to facilitate movement along ground surfaces GS, the representative version of the base 62 includes a plurality of caster wheel assemblies 80 operatively connected adjacent to each corner of the base frame 63 defined by the longitudinally-extending rails 72, 74 and the crosswise-extending rails 76, 78. As such, the patient transport apparatus 20 of FIG. 1 may include four caster wheel assemblies 80. The wheel assemblies 80 may be configured to swivel to facilitate turning of the patient transport apparatus 20. The wheel assemblies 80 may include a swivel locking mechanism to prevent the wheel assemblies 80 from swiveling when engaged. The wheel assemblies 80 may also include wheel brakes 82 to prevent rotation of the wheel. While the base frame 63 of the illustrated version of the base 62 has a generally rectangular profile, it will be appreciated that other configurations are contemplated, including versions where the base 62 is configured without a discrete base frame 63.

The patient transport apparatus 20 also includes a lift mechanism 84 interposed between the base 62 and the litter 22. The lift mechanism 84 is configured to move the litter 22 relative to the base 62 between a plurality of vertical configurations including a raised configuration (see FIG. 1), a lowered configuration (not shown in detail), and one or more configurations therebetween. It will be appreciated that various different distances are achievable between the base 62 and the litter 22, and that the lift mechanism 84 is configured to support the litter 22 for movement between a number of different configurations between a maximum lowered configuration and a maximum raised configuration (not shown in detail). In some versions, the lift mechanism 84 or other components of the patient transport apparatus 20 may be similar to as is described in one or more of U.S. Pat. Nos. 10,987,268 and 10,987,260, previously referenced. Other configurations are contemplated.

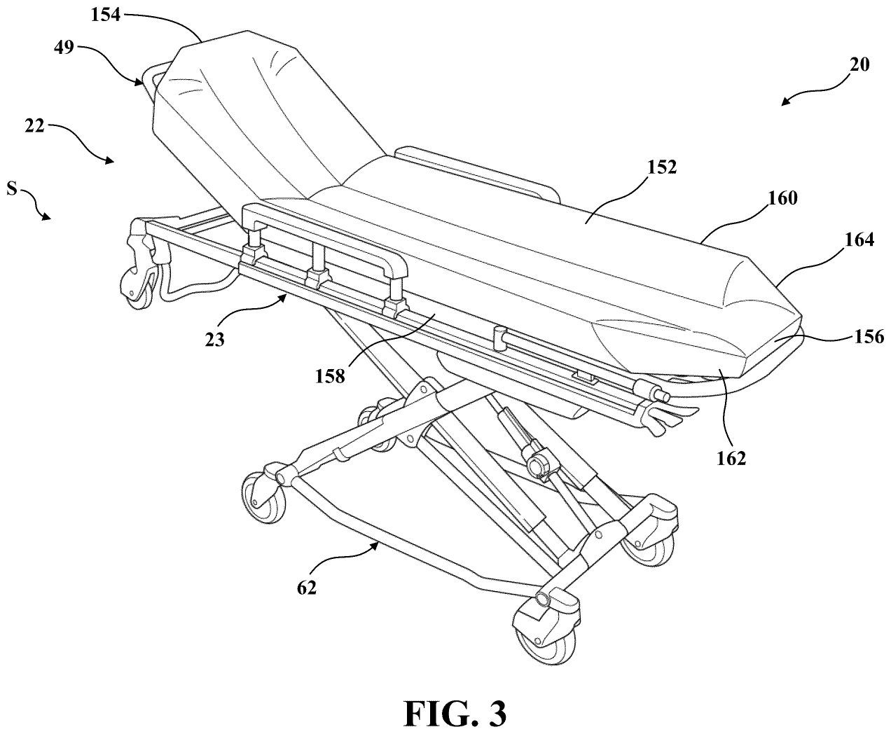

While moving between the plurality of vertical configurations, the lift mechanism 84 may move either the base 62 or the litter 22 relative to the other of the litter 22 or the base 62 depending on how the patient transport apparatus 20 is supported during use. For instance, in FIGS. 3-4, the patient transport apparatus 20 is supported by the base 62 resting on the ground surface GS. In other instances, the patient transport apparatus 20 may be supported at the litter 22, such as during loading or unloading into the emergency response vehicle (not shown). In instances where the patient transport apparatus 20 is supported at the litter 22, the lift mechanism 84, while moving between the plurality of vertical configurations, moves the base 62 relative to the litter 22. In instances where the patient transport apparatus 20 is supported at the base 62, the lift mechanism 84, while moving between the plurality of vertical configurations, moves the litter 22 relative to the base 62.

The patient transport apparatus 20 may include a variety of components that allow the lift mechanism 84 to move between the plurality of vertical configurations. For example, in the version depicted in FIGS. 1-2, the patient transport apparatus 20 includes a bracket 96 and a slidable member 98 disposed within a channel 100 of the bracket 96 and being moveable between a plurality of different positions in the channel 100. The bracket 96 may be coupled to a variety of locations on the patient transport apparatus 20. For example, the bracket 96 may be coupled to the frame 23. More specifically, in the illustrated version, the bracket 96 is coupled to an underside of the side rail 34 of side 30 of the frame 23. In other versions, however, the bracket 96 may be coupled to a different location on the patient transport apparatus 20. For instance, the bracket 96 may be coupled to a side of the side rail 34 which is closest to side 28. In another example, the bracket 96 may be coupled to the patient support surface 50. Furthermore, while a single bracket 96 is shown as being coupled to side 30 of the frame 23 in FIGS. 1-2, another bracket 96 may be coupled to side 28 of the frame 23. For example, another bracket 96 may also be coupled to an underside of the side rail 32 of side 28 of the frame 23.

The channel 100 may have various configurations and shapes, e.g., straight, zig-zag, S-shaped, curved, diagonal/sloped, or any combination thereof. For example, the channel 100 may have a linear shape. In other versions, the channel 100 may have a non-linear shape, a piecewise shape, a curvilinear shape, or any combination of linear or non-linear shapes. The bracket 96 and the channel 100 can be like that shown in one or more of U.S. Pat. Nos. 10,987,268 and 10,987,260, previously referenced. Other configurations are contemplated. As the slidable member 98 moves between the plurality of different positions within the channel 100, the lift mechanism 84 moves between the plurality of vertical configurations. In this way, each position of the slidable member 98 in the channel 100 corresponds to a vertical configuration of the lift mechanism 84. The slidable member 98, channel 100, and/or other portions of the lift mechanism 84 may be similar to as is described in one or more of U.S. Pat. Nos. 10,987,268 and 10,987,260, previously referenced. Other configurations are contemplated.

In the representative version depicted herein, the lift mechanism 84 includes a first frame member 102 and a second frame member 104, both of which are coupled to the litter 22 and the base 62. A first end 106 of the second frame member 104 may be pivotally coupled to the head-end of the frame 23 at a connection point 108 such that the second frame member 104 may pivot about the connection point 108. A second end 110 of the second frame member 104 may be pivotally coupled to a foot-end of the base frame 63 at a connection point 112 such that the second frame member 104 may pivot about the connection point 112. Furthermore, a first end 114 of the first frame member 102 may be pivotally coupled to a foot-end of the frame 23 via the slidable member 98. More specifically, and as shown in FIG. 1, the first end 114 may be pivotally coupled to the slidable member 98, which is disposed in the channel 100 of the bracket 96, which is coupled to the frame 23. Accordingly, the first frame member 102 is pivotally coupled to the frame 23 and may pivot about the slidable member 98. Also shown, a second end 116 of the first frame member 102 may be pivotally coupled to a head-end of the base frame 63 at a connection point 118 such that the first frame member 102 may pivot about the connection point 118. Furthermore, the first frame member 102 and the second frame member 104 may be pivotally coupled to each other at the pivot axle 120 to form an “X” frame 122.

The lift mechanism 84 may include a second, similarly constructed X frame 124, which may include a third frame member 126 and a fourth frame member 128. Similar to X frame 122, the third frame member 126 and the fourth frame member 128 of X frame 124 may be pivotally coupled to a side of the frame 23 and a side of the base frame 63. For example, the third frame member 126 and the fourth frame member 128 of X frame 124 may be pivotally coupled to a side of the frame 23 and a side of the base frame 63, which oppose a side of the frame 23 and a side of the base frame 63 to which the first frame member 102 and the second frame member 104 are coupled. In the versions shown in FIG. 1, X frame 124 is coupled to one side 28 of the frame 23 and to one side 68 of the base frame 63, and X frame 122 is coupled to the other side 30 of the frame 23 and to the other side 70 of the base frame 63. It will be appreciated that any reference herein to the first frame member 102 may also be a reference to the third frame member 126. Similarly, any reference to the second frame member 104 may also be a reference to the fourth frame member 128.

In FIG. 1, the frame members 102, 104, 126, 128 are hollow and telescopingly include further frame members 130, 132, 134, 136, respectively. Further frame members 130, 132, 134, 136 are supported for movement into and out of the respective frame members 102, 104, 126, 128 to extend a length of the respective frame members 102, 104, 126, 128. In the version shown in FIG. 1, the further frame members 130, 132, 134, 136 extend out of frame members 102, 104, 126, 128 toward the base 62. However, in other examples, the further frame members 130, 132, 134, 136 may extend out of frame members 102, 104, 126, 128 toward the litter 22. In these examples, frame members 102, 104, 126, 128 are coupled to the base 62 or the litter 22 via further frame members 130, 132, 134, 136. However, in other examples, the frame members 102, 104, 126, 128 may be of a fixed length and exclude further frame members 130, 132, 134, 136. Additionally, while the lift mechanism 84 of the representative version illustrated in FIG. 1 includes four frame members 102, 104, 126, 128, the lift mechanism 84 may include any suitable number of frame members.

Those having ordinary skill in the art will appreciate that the lift mechanism 84 may move between the plurality of vertical configurations in various ways depending, for example, on the specific configuration of the patient transport apparatus 20 and/or how a caregiver is using the patient transport apparatus 20. By way of illustrative example, in some versions the lift mechanism 84 may be configured for “manual” operation by one or more caregiver to facilitate adjusting the height of the litter 22 relative to the base 62, and in some versions the lift mechanism 84 may employ one or more actuators 138 to facilitate “powered” operation to adjust the height of the litter 22 relative to the base 62. It will be appreciated that the lift mechanism 84 of the patient transport apparatus 20 could employ any suitable number of actuators 138, which may be coupled to any suitable component of the support structure 21 and may be configured to move the lift mechanism 84 between the plurality of vertical configurations. The illustrated actuator 138 is realized as a hydraulic linear actuator, which is connected to and extends between brackets 140 and 142. In this version, the actuator 138 includes a cylindrical housing 144 fastened to the bracket 142 and supporting a reciprocal rod 146 having a piston located within the cylindrical housing 144 (not shown in detail). The distal end of the reciprocal rod 146 is connected by a joint 150 to the bracket 140. The joint 150 allows pivotal movement about two orthogonally related axes. Extension and retraction of the reciprocal rod 146 will facilitate movement of the frame members 102, 126 of the lift mechanism 84 about the axis of the reciprocal rod 146. In some versions, the actuator 138 may not be the hydraulic linear actuator. The actuator 138 may be any actuator suitable for actuating the lift mechanism 84 such that the lift mechanism 84 moves between the plurality of vertical configurations. For example, the actuator 138 may be an electric motor, a servo motor, a pneumatic actuator, or any other suitable actuator. In some versions, the actuator 138 may be similar to as is described in U.S. Pat. No. 7,398,571, the disclosure of which is hereby incorporated by reference in its entirety. Furthermore, techniques for utilizing actuator 138 to manipulate the components of the patient transport apparatus 20 can be like those described in one or more of U.S. Pat. Nos. 10,987,268 and 10,987,260, previously referenced. Other configurations are contemplated.

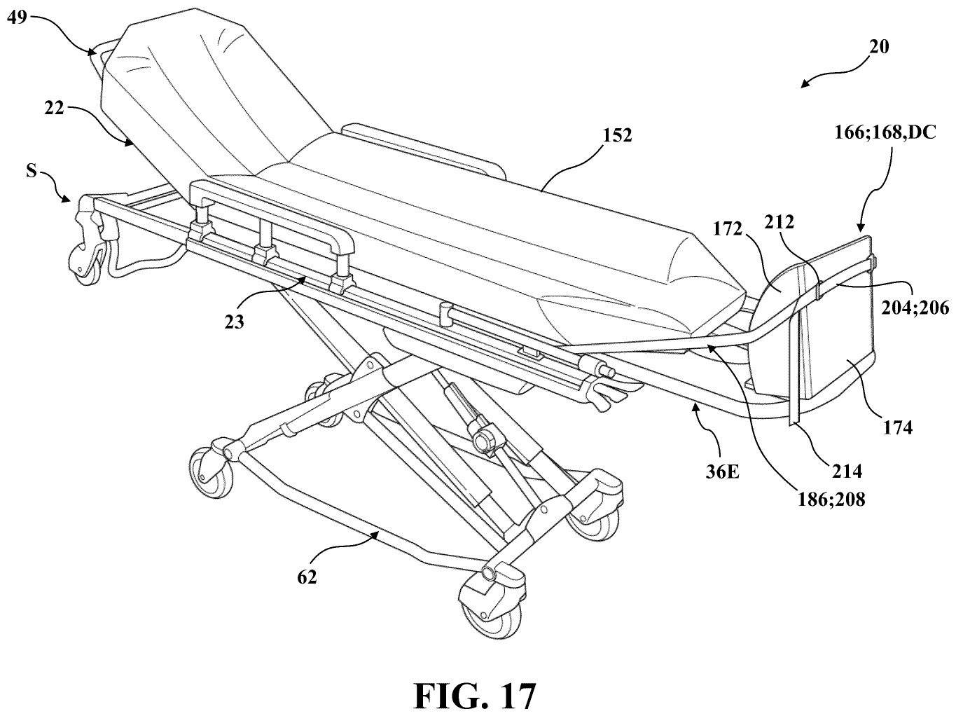

Referring to FIG. 3, the mattress 152 is disposed on the patient support deck 49 (see FIG. 4). The mattress 152 defines opposing first and second longitudinal mattress ends 154. The first longitudinal mattress end 154 is arranged adjacent to the head-end of the litter 22, and the second longitudinal mattress end 156 arranged adjacent to the foot-end of the litter. The mattress 152 also defines first and second lateral mattress sides 158,160. Put more simply, the first and second lateral mattress sides 158, 160 may be referred to as the left and right sides of the mattress 152. In the illustrated version, and as is best depicted in FIG. 3 (see also FIG. 17), the mattress 152 also includes first and second tapered mattress edges 162, 164. The first and second tapered mattress edges 162, 164 extend respectively between the first and second lateral mattress sides 158, 160 and the longitudinal mattress end 156. The first tapered mattress edge 162 is adjacent to the first lateral mattress side 158. Likewise, the second tapered mattress edge 160 is adjacent to the second lateral mattress side 164. Although the drawings depict the mattress 152 as having first and second tapered mattress edges 162, 164, it should be appreciated that in other versions, the mattress 152 may have no tapered edges, or may have different quantities and/or configurations of tapered edges.

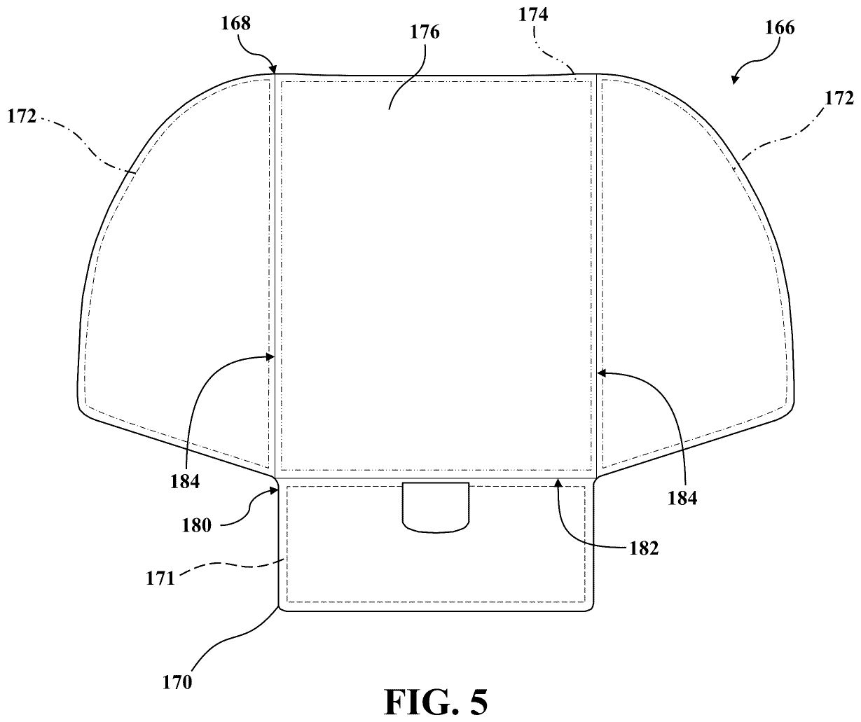

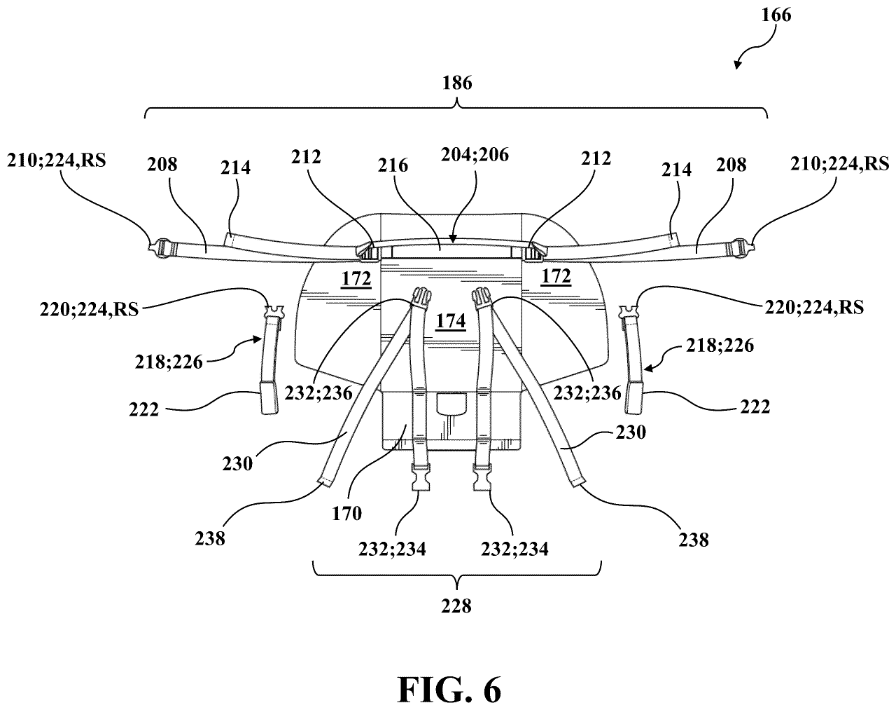

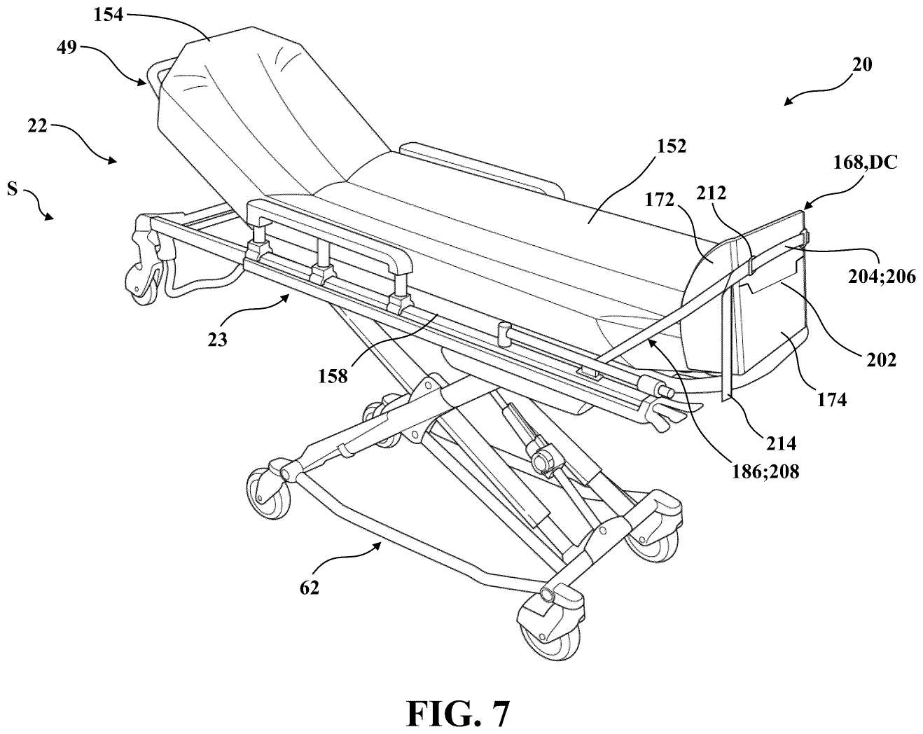

As noted above, the patient support system S generally includes the patient transport apparatus 20 and the foot barrier 166 which is operatively attached to the litter 22. As is best depicted in FIGS. 5-6, the foot barrier 166 generally includes a shield 168, a bottom 170, and a brace 186. In some versions, the bottom 170 of the foot barrier 166 is operatively attached to the patient support deck 49, such as to the foot section 55 (see FIG. 4). In some versions, the bottom 170 of the foot barrier 166 is operatively attached to the litter extension 36 (see FIGS. 15A-15B) for concurrent movement between the plurality of litter extension positions 36E, 36R. The shield 168 includes a pair of side panels 172 each pivotally coupled to a center panel 174 which, in turn, is pivotally coupled to the bottom 170. The shield 168 is operable between: a stowed configuration SC (see FIG. 4) where the center panel 174 and the side panels 172 are disposed between the patient support deck 49 and the mattress 152, and a deployed configuration DC (see FIG. 7) where the center panel 174 and the side panels 172 extend at least partially above the mattress 152 for shielding a caregiver from at least a portion of the patient. The brace 186 is coupled to the shield 168 and is arranged for attachment to the litter 22 to maintain the shield 168 in the deployed configuration DC. Each of the components of the foot barrier 166 introduced above will be described in greater detail below.

As is best shown in FIGS. 5 and 6, the center panel 174 includes a front center panel face 176 and an opposing back center panel face 178. In the illustrated versions, during operation in the stowed configuration SC (see FIG. 4), the center panel 174 and the side panels 172 are disposed between the patient support deck 49 and the mattress 152. More specifically, the front center panel face 176 is disposed adjacent to the patient support deck 49, and at least a portion of the back center panel face 178 abuts the mattress 152 adjacent to the longitudinal mattress end 156. Moreover, because the side panels 172 fold inward towards the center panel 174 such that the center panel 174 is arranged parallel to the side panels 172 (see FIG. 4; not shown in detail), one or more of the side panels 127 may at least partially abut the center panel 174 and/or the patient support deck 49 during operation in the stowed configuration SC.

In the illustrated versions, the bottom 170 includes a bottom panel 171 which, along with the panels 172, 174 of the shield 168 are formed as separate rigid (or semi-rigid), generally flat components which are coupled together for pivoting movement relative to adjacent components. To this end, the foot barrier 166 includes a cover 180 enclosing the bottom panel 171 of the bottom 170 and the panels 172, 174 of the shield 168. The cover 180 may be made from a relatively flexible material that allows for pivoting movement of the panels 172, 174, such as with two flexible sheets which are bonded together and/or to the panels 172, 174 (not shown in detail). The cover 180 defines a shield hinge 182 between the bottom panel 171 of the bottom 170 and the center panel 174 as shown in FIG. 5. The shield hinge 182 provides support for the center panel 174 to pivot away from the bottom 170. The cover 180 also defines side hinges 184 between the respective side panels 172 and the center panel 174. Similar to the shield hinge 182, the side hinges 184 provide support for the pair of side panels 172 to pivot relative to the center panel 174.

As noted above, the shield 168 is maintained in the deployed configuration DC by the brace 186. During operation in the deployed configuration DC, such as is depicted in FIG. 7, the center panel 174 and the side panels 172 each extend at least partially above the mattress 152 for shielding a caregiver from at least a portion of the patient, as noted above. In some versions, at least a portion of the shield 168 abuts the second longitudinal mattress end 156 in the deployed configuration DC.

It will be appreciated that the ability of the foot barrier 166 to change operation between the stowed configuration SC and the deployed configuration DC allows a caregiver to quickly erect a protective barrier when needed and secure it in a readily-accessible location on the patient transport apparatus 20. Thus, the foot barrier 166 is moved concurrently with the patient transport apparatus 20 and does not need to be stored elsewhere (e.g., in an ambulance cargo area) and subsequently attached to the patient transport apparatus 20. Moreover, it will be appreciated that the operation of the foot barrier 166 in the stowed configuration SC beneath the mattress 152 does not interfere with normal patient care and, at the same time, does not present risks of the stowed foot barrier 166 becoming dislodged or otherwise interfering with operation of the patient transport apparatus 20 (e.g., operation of the lift mechanism 84, articulation of the patient support deck 49, and the like).

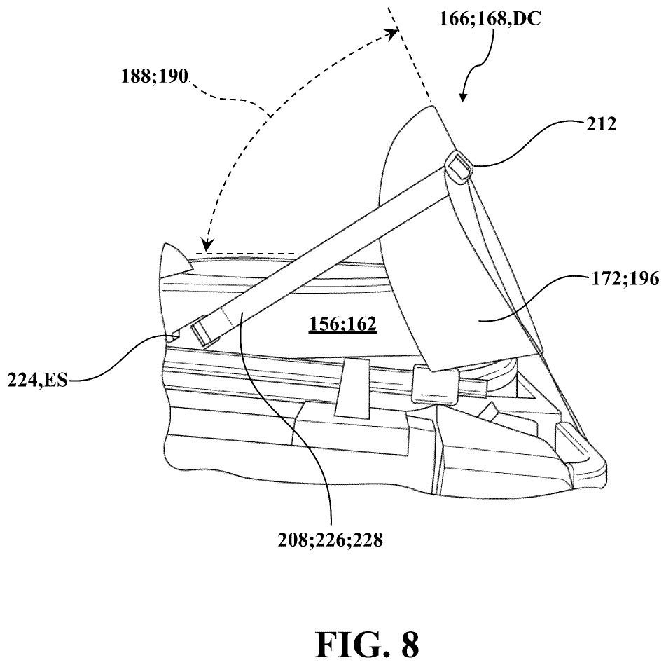

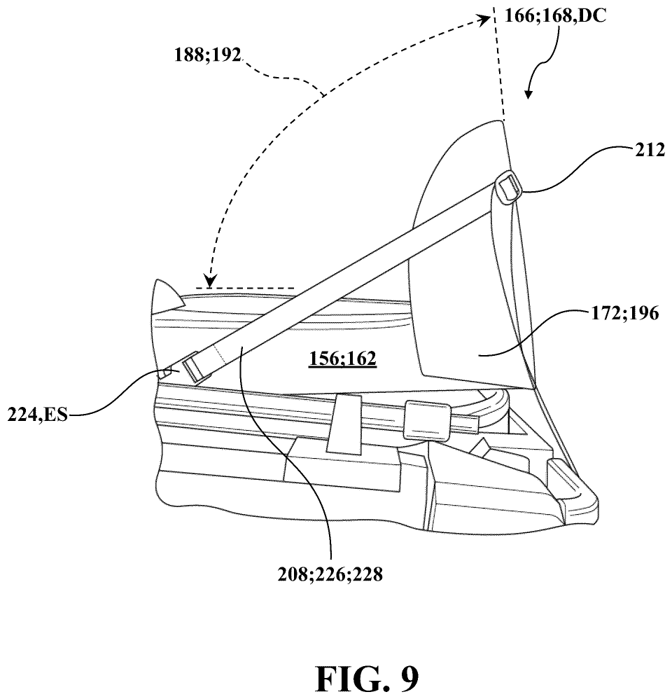

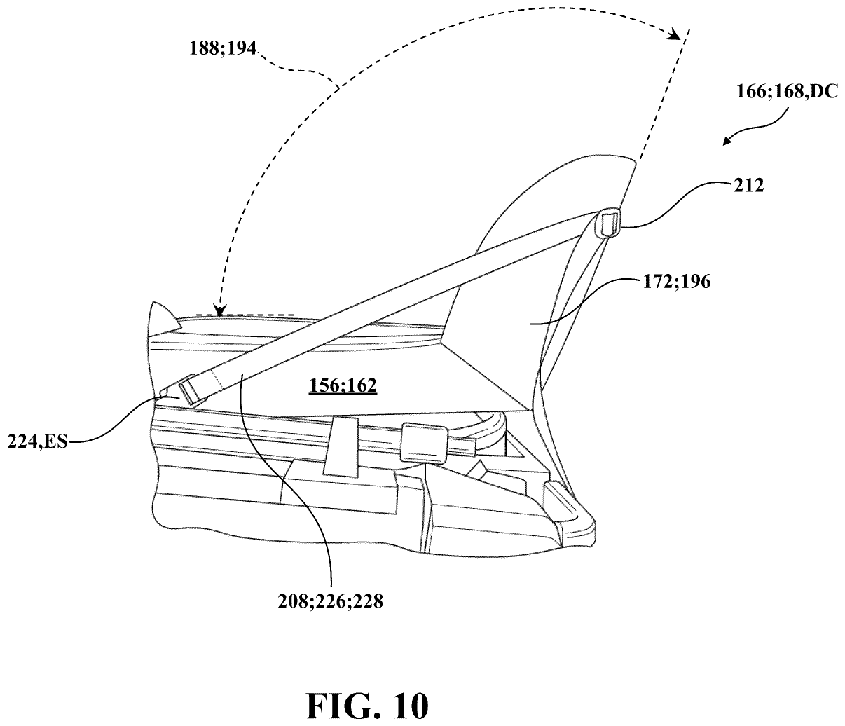

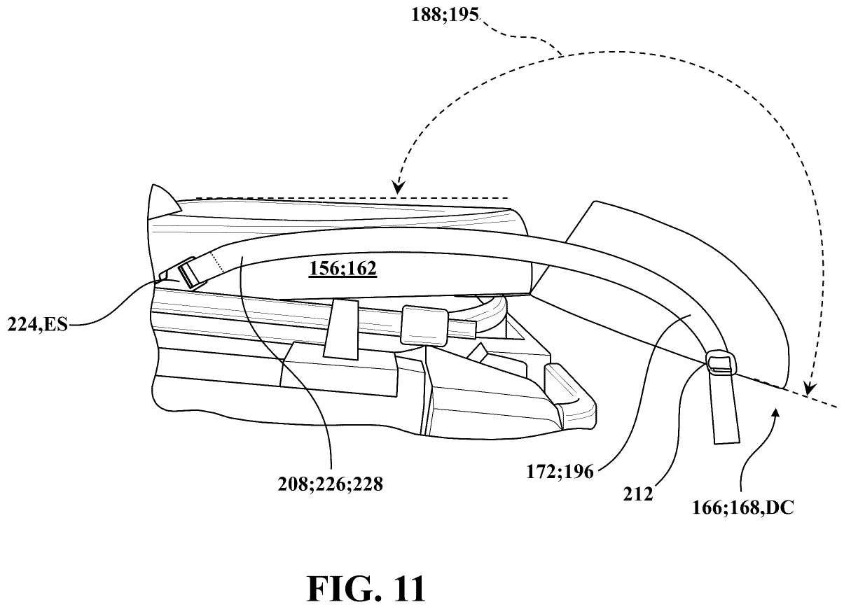

The center panel 174 is disposed adjacent to the bottom 170 in the stowed configuration SC and pivots away from the bottom 170 to a center panel angle 188 in the deployed configuration DC. The center panel angle 188 may be defined relative to the mattress 152 or another component of the litter 22, and may be adjustable, such as via the brace 186 as described in greater detail below. In some versions, the center panel angle 188 may be an acute angle 190 (see FIG. 8), a right angle 192 (see FIG. 9), an obtuse angle 194 (see FIG. 10), or a reflex angle 195 (see FIG. 11). It will be appreciated that adjustment of the center panel angle 188 provides flexibility for the patient's feet while the foot barrier 166 is deployed, such that the protective barrier remains between the caregiver and the patient while in use. For example, in the deployed configuration DC, the center panel angle 188 may be the right angle 192 where the center panel 174 is angled at ninety degrees relative to the mattress 152 as shown in FIG. 9. At the right angle 192, the shield 168 may accommodate the height of most patients, allowing the foot barrier 166 to protect the caregiver. In another scenario, the center panel angle 188 may have an acute angle 190, where the center panel 174 is angled inward relative to the mattress 152, less than ninety degrees as shown in FIG. 8. Here, the patient may be short and it is beneficial to the caregiver to have the ability to adjust the shield 168 of the foot barrier 166 inward, which would otherwise leave the patient's feet exposed. On the other hand, the patient may be relatively tall, which may require the center panel 174 to be angled outward relative to the mattress 152, creating an angle between ninety and one hundred eighty degrees as shown in FIG. 10. In some versions, the caregiver may need to access the patient's feet or otherwise facilitate the foot end 28 of the litter 22, and may adjust the shield 168 of the foot barrier 166 outward by adjusting the center panel angle 188 to the reflex angle 195 (see FIG. 11) which places the shield 168 in a folded out configuration. Other configurations are contemplated.

Similar to the center panel 188, the pair of side panels 172 may be adjustable to different angles relative to the mattress 152 wherein the respective side panel angles 196 are a right angle 198 or an obtuse angle 200 (not shown in detail). For example, the side panels 172 may form the right angle 198 in situations where the pair of side panels 172 are pressed close to first and second tapered mattress edges 162, 164 of the mattress 152 with the brace 186 to maintain the deployed configuration DC. In some versions, the side panel angles 196 are at least partially defined based on the shape of the mattress 152. In some versions, the pair of side panels 172 may form the obtuse angle 200 in situations where the pair of side panels 172 are close to the mattress 152 but not pressed against it. It will be appreciated that when the foot barrier 166 is in the deployed configuration DC, the side panel angles 196 may change based on how the brace 186 is maintaining the deployed configuration DC as described in greater detail below.

In some versions, such as is depicted in FIG. 7, the foot barrier 166 may include includes a pocket 202 coupled to the back center panel face 178 or another portion of the shield 168 for storing equipment, paperwork, clipboards, and the like. The pocket 202 may be of various sizes, configurations, and/or or shapes and may be disposed in various locations. In some versions, multiple pockets 202 may be utilized. The pocket 202 may include fasteners or other features to close the pocket 202 such as a button, a zipper, magnetic elements, hook-and-loop fasteners, and the like. Other configurations are contemplated.

As noted above, the brace 186 is coupled to the shield 168 and to the litter 22 and maintains operation in the deployed configuration DC. In some versions, as depicted in FIG. 6, the brace 186 includes a center brace 204 operatively attached to the center panel 174, and a pair of side braces 226 operatively attached to the litter 22 adjacent to the patient support deck 49 and coupled to the center brace 204 to maintain the shield 168 in the deployed configuration DC. In some versions, the center brace 204 and/or the side braces 226 may abut or otherwise engage at least a portion of the side panels 172 in the deployed configuration DC. In the representative versions illustrated herein, one or more components of the brace 186 may be realized as straps, such as webbing or similar flexible materials.

As depicted in FIG. 6, in some versions the brace 186 includes a pair of fasteners 224 each coupled to a respective one of the side braces 226 and to the center brace 204. The fasteners 224 are operable between an engaged fastener state ES (see FIGS. 8-11) and a released fastener state RS (see FIG. 6). In the engaged fastener state ES, the fasteners 224 maintain the shield 168 in the deployed configuration DC with the side braces 226 coupled to the center brace 204. In the released fastener state RS, the fasteners 224 release the side braces 226 from the center brace 204. In some versions, the released fastener state RS may be employed so as to allow for the shield 168 of the foot barrier 166 to be removed from the patient transport apparatus 20 independent of the side braces 226 of the foot barrier 166, such as for cleaning or replacement. In some versions, the released fastener state RS may be employed so as to allow for the shield 168 to be placed into the stowed configuration SC with the side braces 226 disconnected from the center brace 204. However, other configurations are contemplated, and it will be appreciated that the stowed configuration SC may also be achieved during operation in the engaged fastener state ES. In the illustrated version depicted in FIG. 6, the side braces 226 each include a respective side strap 218 defining a loop segment 222 for attaching the side braces 226 to the litter 22, such as by tying around the intermediate frame 23. Here, the fasteners 224 each include a first buckle end 210 coupled to the center brace 204, and a second buckle end 220 attached to one of the side straps 218.

In this version, the center brace 204 includes a center mount 206 coupled to the center panel 174 of the shield 168. It will be appreciated that that the center mount 206 can be coupled to the shield 168 in various ways, such as by one or more of adhesives, stitching, zippers, and the like. The center brace 204 also includes a pair of adjusters 212 coupled to the center mount 206, and a pair of center straps 208 extending through the respective adjusters 212. The center straps 208 are routed through the adjusters 212 for adjustment to pivot the shield 168 relative to the bottom 170, such as to adjust the center panel angle 188 (compare FIGS. 8-11). In some versions, one or more adjusters 212 may be arranged for user engagement to modify at least one of the center panel angle 188 and the side panel angles 196. It will be appreciated that the center panel angle 188 and/or the side panel angles 196 may also be adjusted based on where the braces 186 are coupled to the litter 22. In the illustrated version, pull handles 214 are defined by or otherwise attached to the center straps 208 and are arranged for engagement by a caregiver to adjust the center straps 208 relative to the adjusters 212 (see also FIG. 14).

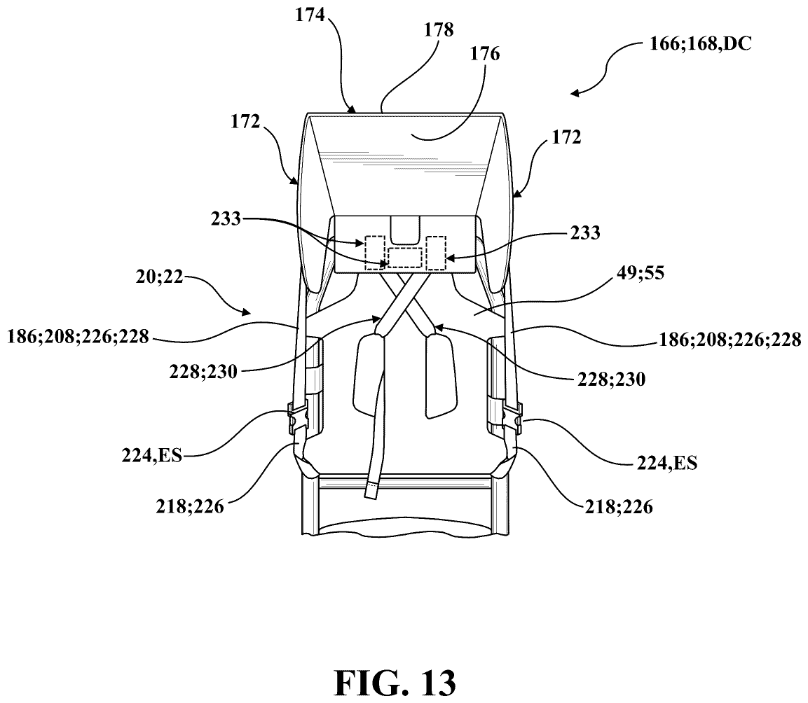

In some versions, the center brace 204 further includes a center handle 216 operatively attached to the adjusters 212 (see FIG. 13) or to another part of the center brace 204. The center handle 216 may be used to assist with moving the foot barrier 166 between the stowed configuration SC and the deployed configuration DC. For example, when the foot barrier 166 is in the stowed configuration SC, the caregiver may pull on the center handle 216 to help place the foot barrier 166 into the deployed configuration DC. The center brace 204 is disposed between the center panel 174 and at least one of the side panels 172 in the stowed configuration SC.

As is best depicted in FIG. 6, the foot barrier 166 includes a mount 228 spaced from the brace 186 for securing the foot barrier 166 for movement relative to the litter 22 between the stowed configuration SC and the deployed configuration DC. Put differently, the mount 228 secures the foot barrier 166 to the patient transport apparatus 20. In the illustrated version, the mount 228 is operatively attached to the bottom 170 of the foot barrier 166 (see also FIG. 10). In some versions, the mount 228 includes a mount strap 230 and a mount fastener 232. The mount strap 228 is arranged for engagement with at least a portion of the patient support deck 49 of the litter 22. The mount fastener 232 is coupled to the mount strap 230 and configured to releasably secure the mount strap 230 to the patient support deck 49 of the litter 22. The mount strap 230 may be routed between the gaps in the bottom 170 and the patient support deck 49. For example, the mount strap 230 may be directed over and/or under the patient support deck 49 preventing the mount strap 230 from coming loose. In some versions, and as is depicted schematically in FIG. 13, the mount 228 may additionally or alternatively include an arrangement of one or more hook and loop fastener portions 233 respectively coupled to the patient support deck 49 (e.g., one or more hook portions) and to the bottom 170 of the foot barrier 166 (e.g., one or more loop portions). Other configurations are contemplated, and it will be appreciated that the mount 228 may include any suitable arrangement of hook and loop fastener portions 233, or may omit hook and loop fastener portions in some versions.

In the illustrated version, and as is best depicted in FIG. 6, a pair of mount straps 230 are provided with a respective pair of mount fasteners 232. Here, the mount fasteners 232 each include a fixed buckle end 234 and an adjuster buckle end 236 configured for releasable engagement with the fixed buckle end 234 and slidably disposed along the respective mount straps 230 between the fixed buckle end 234 and a free strap end 238 of the mount straps 230. This configuration allows the length of the mount strap 230 to be adjusted and releasably secured to the litter 22.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### Clauses

I. A patient support system comprising:
a patient transport apparatus including:
   a base supporting a plurality of wheels arranged for movement along a floor surface,
   a litter including a patient support deck, and
   a mattress disposed on the patient support deck to support a patient; and
a foot barrier being operatively attached to the litter and including:
   a bottom,
   a shield having a center panel pivotally coupled to the bottom, and a pair of side panels each pivotally coupled to the center panel, the shield being operable between:
      a stowed configuration where the center panel and the side panels are disposed between the patient support deck and the mattress, and
      a deployed configuration where the center panel and the side panels extend at least partially above the mattress for shielding a caregiver from at least a portion of the patient; and
   a brace coupled to the shield and arranged for attachment to the litter to maintain the shield in the deployed configuration.

II. The patient support system of clause I, wherein the center panel is arranged parallel to the side panels in the stowed configuration.

III. The patient support system of any preceding clause, wherein the center panel is disposed adjacent to the bottom in the stowed configuration and pivots away from the bottom to a center panel angle in the deployed configuration.

IV. The patient support system of clause III, wherein the brace includes an adjuster arranged for user engagement to modify the center panel angle.

V. The patient support system of any of clauses III-IV, wherein the side panels are each disposed adjacent to the center panel in the stowed configuration and pivot away from the center panel to respective side panel angles in the deployed configuration.

VI. The patient support system of clause V, wherein the brace includes an adjuster arranged for user engagement to modify one or more of the center panel angle and the side panel angles.

VII. The patient support system of clauses V-VI, wherein the center panel angle is one of an acute angle, a right angle, an obtuse angle, or a reflex angle.

VIII. The patient support system of any of clauses V-VII, wherein the respective side panel angles are a right angle or an obtuse angle.

IX. The patient support system of clause VIII, wherein the mattress defines a longitudinal mattress end; and
wherein the center panel of the shield abuts the longitudinal mattress end in the deployed configuration.

X. The patient support system of clause IX, wherein the mattress further defines first and second lateral mattress sides, and first and second tapered mattress edges extending respectively between the first and second lateral mattress sides and the longitudinal mattress end; and
wherein the side panels of the shield each respectively abut one of the first and second tapered mattress edges in the deployed configuration.

XI. The patient support system of any preceding clause, wherein the center panel defines a front center panel face and an opposing back center panel face;
wherein the front center panel face is disposed adjacent to the patient support deck in the stowed configuration; and
wherein the back center panel face abuts the mattress in the stowed configuration.

XII. The patient support system of clause XI, wherein the foot barrier further includes a pocket coupled to the back center panel face for storing equipment.

XIII. The patient support system of any preceding clause, wherein the brace includes a center brace operatively attached to the center panel, and a pair of side braces operatively attached to the litter adjacent to the patient support deck and coupled to the center brace and to maintain the shield in the deployed configuration.

XIV. The patient support system of clause XIII, wherein the brace further includes a pair of fasteners each coupled to a respective one of the side braces and to the center brace, the fasteners being operable between:
an engaged fastener state to maintain the shield in the deployed configuration with the side braces coupled to the center brace, and
a released fastener state for releasing the side braces from the center brace.

XV. The patient support system of clause XIV, wherein the side braces each include a respective side strap defining a loop segment for attaching the side braces to the litter.

XVI. The patient support system of any of clauses XIV-XV, wherein the side braces each include a respective side strap; and
wherein the fasteners each include a first buckle end coupled to the center brace, and a second buckle end attached to one of the side straps.

XVII. The patient support system of clause XVI, wherein the center brace includes:
a center mount operatively attached to the center panel of the shield,
a pair of adjusters coupled to the center mount, and
a pair of center straps extending through the respective adjusters and operatively attached to the first buckle ends of the respective fasteners.

XVIII. The patient support system of clause XVII, wherein the center straps of the brace are routed through the adjusters for adjustment to pivot the shield relative to the bottom.

XIX. The patient support system of clause XVIII, wherein the brace further includes a pair of pull handles operatively attached to the center straps and arranged for engagement to adjust the center straps.

XX. The patient support system of any of clauses XVIII-XIX, wherein the center brace further includes a center handle operatively attached to the adjusters.

XXI. The patient support system of any preceding clause, wherein the foot barrier further includes a mount spaced from the brace for securing the foot barrier for movement relative to the litter between the stowed configuration and the deployed configuration.

XXII. The patient support system of clause XXI, wherein the mount is operatively attached to the bottom of the foot barrier.

XXIII. The patient support system of any of clauses XXI-XXII, wherein the mount includes:
a mount strap arranged for engagement with at least a portion of the patient support deck of the litter, and
a mount fastener coupled to the mount strap and configured to releasably secure the mount strap to the patient support deck of the litter.

XXIV. The patient support system of clause XXIII, wherein the mount strap is operatively attached to the bottom of the foot barrier.

XXV. The patient support system of any preceding clause, wherein the center panel abuts at least one of the side panels in the stowed configuration.

XXVI. The patient support system of any preceding clause, wherein the foot barrier includes a cover enclosing the bottom and the shield.

XXVII. The patient support system of clause XXVI, wherein the cover defines a shield hinge between the bottom and the center panel.

XXVIII. The patient support system of any of clauses XXVI-XXVII, wherein the cover defines side hinges between the respective side panels and the center panel.

XXIX. The patient support system of any preceding clause, wherein the litter includes an intermediate frame and a litter extension supported for movement relative to the intermediate frame between a plurality of litter extension positions including a retracted litter position and one or more extended litter positions; and
wherein the bottom of the foot barrier is operatively attached to the litter extension for concurrent movement between the plurality of litter extension positions.

XXX. The patient support system of any of clauses I-XXVIII, wherein the bottom of the foot barrier is operatively attached to the patient support deck of the litter.

What is claimed is:

1. A patient support system comprising:
a patient transport apparatus including:
a base supporting a plurality of wheels arranged for movement along a floor surface,
a litter including a patient support deck, and
a mattress disposed on the patient support deck to support a patient; and
a foot barrier being operatively attached to the litter and including:
a bottom,
a shield having a center panel pivotally coupled to the bottom, and a pair of side panels each pivotally coupled to the center panel, the shield being operable between:
a stowed configuration where the center panel and the side panels are disposed between the patient support deck and the mattress, and
a deployed configuration where the center panel and the side panels extend at least partially above the mattress for shielding a caregiver from at least a portion of the patient; and
a brace coupled to the shield and arranged for attachment to the litter to maintain the shield in the deployed configuration.

2. The patient support system of claim 1, wherein the center panel is arranged parallel to the side panels in the stowed configuration.

3. The patient support system of claim 1, wherein the center panel is disposed adjacent to the bottom in the stowed configuration and pivots away from the bottom to a center panel angle in the deployed configuration.

4. The patient support system of claim 3, wherein the side panels are each disposed adjacent to the center panel in the stowed configuration and pivot away from the center panel to respective side panel angles in the deployed configuration.

5. The patient support system of claim 4, wherein the brace includes an adjuster arranged for user engagement to modify one or more of the center panel angle and the side panel angles.

6. The patient support system of claim 4, wherein the center panel angle is one of an acute angle, a right angle, an obtuse angle, or a reflex angle.

7. The patient support system of claim 4, wherein the respective side panel angles are a right angle or an obtuse angle.

8. The patient support system of claim 7, wherein the mattress defines a longitudinal mattress end; and
wherein the center panel of the shield abuts the longitudinal mattress end in the deployed configuration.

9. The patient support system of claim 8, wherein the mattress further defines first and second lateral mattress sides, and first and second tapered mattress edges extending respectively between the first and second lateral mattress sides and the longitudinal mattress end; and
wherein the side panels of the shield each respectively abut one of the first and second tapered mattress edges in the deployed configuration.

10. The patient support system of claim 1, wherein the center panel defines a front center panel face and an opposing back center panel face;
wherein the front center panel face is disposed adjacent to the patient support deck in the stowed configuration;
wherein the back center panel face abuts the mattress in the stowed configuration; and
wherein the foot barrier further includes a pocket coupled to the back center panel face for storing equipment.

11. The patient support system of claim 1, wherein the brace includes a center brace operatively attached to the center panel, and a pair of side braces operatively attached to the litter adjacent to the patient support deck and coupled to the center brace and to maintain the shield in the deployed configuration; and
wherein the brace further includes a pair of fasteners each coupled to a respective one of the side braces and to the center brace, the fasteners being operable between:
an engaged fastener state to maintain the shield in the deployed configuration with the side braces coupled to the center brace, and
a released fastener state for releasing the side braces from the center brace.

12. The patient support system of claim 11, wherein the side braces each include a respective side strap defining a loop segment for attaching the side braces to the litter.

13. The patient support system of claim 11, wherein the side braces each include a respective side strap;
wherein the fasteners each include a first buckle end coupled to the center brace, and a second buckle end attached to one of the side straps;
wherein the center brace includes:
a center mount operatively attached to the center panel of the shield,
a pair of adjusters coupled to the center mount, and
a pair of center straps extending through the respective adjusters and operatively attached to the first buckle ends of the respective fasteners, the center straps of the brace being routed through the adjusters for adjustment to pivot the shield relative to the bottom.

14. The patient support system of claim 13, wherein the brace further includes a pair of pull handles operatively attached to the center straps and arranged for engagement to adjust the center straps.

15. The patient support system of claim 13, wherein the center brace further includes a center handle operatively attached to the adjusters.

16. The patient support system of claim 1, wherein the foot barrier further includes a mount operatively attached to the bottom of the foot barrier and spaced from the brace for securing the foot barrier for movement relative to the litter between the stowed configuration and the deployed configuration; and
wherein the mount includes:
a mount strap arranged for engagement with at least a portion of the patient support deck of the litter, and
a mount fastener coupled to the mount strap and configured to releasably secure the mount strap to the patient support deck of the litter.

17. The patient support system of claim 1, wherein the center panel abuts at least one of the side panels in the stowed configuration.

18. The patient support system of claim 1, wherein the foot barrier includes a cover enclosing the bottom and the shield, the cover defining:
a shield hinge between the bottom and the center panel, and
side hinges between the respective side panels and the center panel.

19. The patient support system of claim 1, wherein the litter includes an intermediate frame and a litter extension supported for movement relative to the intermediate frame between a plurality of litter extension positions including a retracted litter position and one or more extended litter positions; and
wherein the bottom of the foot barrier is operatively attached to the litter extension for concurrent movement between the plurality of litter extension positions.

20. The patient support system of claim 1, wherein the bottom of the foot barrier is operatively attached to the patient support deck of the litter.
